(19) United States
(12) Patent Application Publication
(10) Pub. No.: US 2003/0141767 A1
(43) Pub. Date: Jul. 31, 2003

(54) Method of and device for temperature-dependent power control of electrical device

(76) Inventors: Stefan Roepke, Leinfelden (DE); Rainer Glauning, Aichtal-Groetzingen (DE)

Correspondence Address: STRIKER, STRIKER & STENBY, 103 East Neck Road, Huntington, NY, 11743, US

(21) Appl. No.: 10/341,223

(22) Filed: Jan. 13, 2003

(30) Foreign Application Priority Data
Jan. 26, 2002 (DE) 102 03 051.0

(51) Int. Cl. H02B 1/24

(52) U.S. Cl. 307/117

(57) ABSTRACT

A method of controlling the power of an electrical device in dependence on a temperature includes determining a temperature or a variable which depends on the temperature of an element selected from the group consisting of a current supply unit connected with the electrical device, one or several components of the electrical device, and both, and when the determined temperature or a variable which depends on it exceeds a predetermined threshold, reducing power taken from the electrical device until the temperature or a variable which depends on it falls below the threshold or a lower threshold.

### BACKGROUND OF THE INVENTION

The present invention relates to a method of and a device for temperature-dependent control of the power of an electrical device.

It is known that the service life of an electric storage battery for electrical devices is significantly reduced by overheating because of an excessive power withdrawal through the electrical device. In order to protect the electric storage battery from overheating, it is proposed in German document DE 41 06 725 A1 to turn off the electrical device when an excessively high temperature of the electric storage battery is determined. This leads however to the situation that for protection of the electric storage battery an abrupt turning off of the electrical device occurs during its operational process. If the electrical devices is for example a power drill, then in the case of overheating on the electric storage battery the drilling process is suddenly interrupted and the drill remains stuck in the borehole. The power drill can not be turned on to release the drill from the borehole.

### SUMMARY OF THE INVENTION

Accordingly, it is an object of the present invention to provide a method of and a device for temperature-dependent control of power of an electrical device which avoids the disadvantages of the prior art.

In keeping with these objects and with others which will become apparent hereinafter, one feature of the present invention resides, briefly stated, in a method of a temperature-dependent control of the power of an electrical device, which includes the steps of determining a temperature or a variable which depends on the temperature of an element selected from the group consisting of a current supply unit connected with the electrical device, one or several components of the electrical device, and both, and when the determined temperature or a variable which depends on it exceeds a predetermined threshold, reducing power taken from the electrical device until the temperature or a variable which depends on it falls below the threshold or a lower threshold.

In accordance with another feature of the present invention a device for a temperature-dependent control of the power of an electrical device is proposed which includes first means for detecting a temperature or a variable which depends on the temperature of an element selected from the group consisting of a current supply unit connected with the electrical device, one or several components of the electrical device, and both; and second means which, when the detected temperature or a value which depends on it exceeds a predetermined threshold, reduces power taken from the electrical device until the temperature or a value which depends on it falls below said threshold or a lower threshold.

In accordance with the present invention the temperature or a variable which depends on the temperature of a current supply connected with the electrical device and/or the temperature or a variable depending on the temperature of one or several components of the electrical device is determined, and when the determined temperature or a variable which depends on it exceeds a predetermined threshold, the power which is taken by the electrical device is reduced until the temperature or a variable depending on it falls below the same threshold or a lower threshold.

When the current supply unit, which can be an electric storage battery or a power pack, or one or several components of the electrical device are overheating, the electrical device is no longer abruptly turned off, but instead its operated with a reduced power. Thereby at the least the started working process can be brought with reduced power of the machine to the end. Therefore, an interruption of the working process which is unexpected for the operator is avoided in accordance with the present invention.

In accordance with additional features of the present invention when the temperature of the electric storage battery exceeds a predetermined threshold, the power which is received from the electrical device can be reduced either in steps or continuously.

It is also advantageous when the power taken from the electrical device can be increased after falling below a threshold by the temperature or a variable which depends on it, in steps or continuously. In particular, when the current supply unit and/or the electrical device reaches its normal temperature region, the working process can continue with the maximum possible power of the electrical device.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a block diagram of a device for controlling the power of an electrical device, in dependence on the temperature of its current supply unit or its components;

FIG. 2 is a view showing a course of temperature obtained during the operation of the inventive device for controlling the power of an electrical device; and

FIG. 3 is a view showing a stepped and a continuous course of the current which is taken from the electrical device.

### DESCRIPTION OF THE PREFERRED EMBODIMENTS

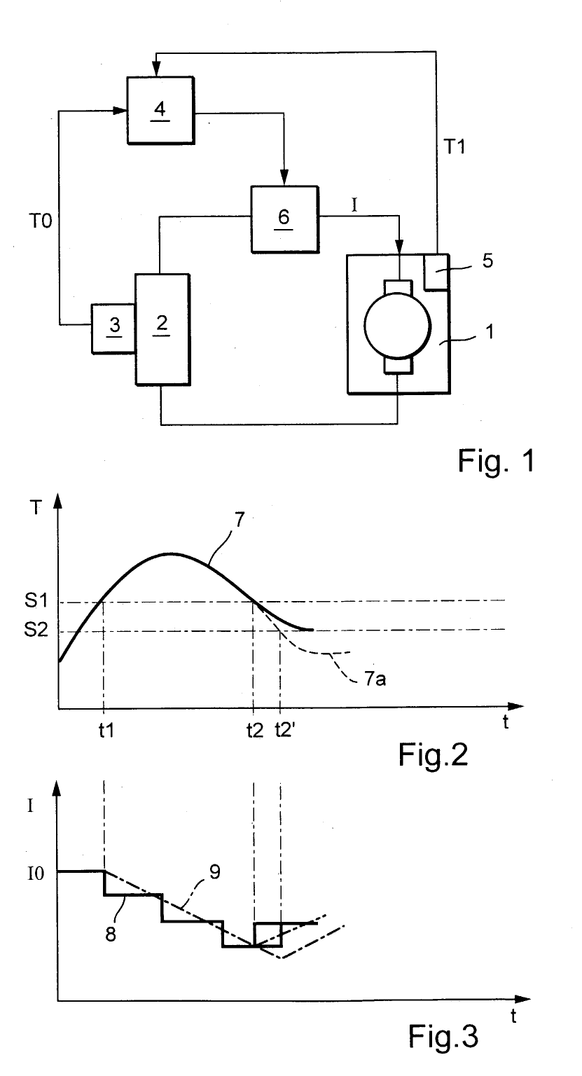

A block diagram presented in FIG. 1 shows an electrical device 1 which is formed for example as a hand power tool, such as a screwdriver, a drill, a saw, a grinder, etc. A current supply unit 2 supplies energy for the drive of the electrical device 1, which drive is illustrated by a symbol of a motor. The current supply unit 2 can be formed as a rechargeable electric storage battery or a battery pack.

A temperature sensor 3 is located on or in the current supply unit 2. It determines the actual temperature of the electric storage battery 2 and transmits the temperature value T0to an evaluating circuit 4. Furthermore, the temperature T1 of one or several components can be also measured in the electrical device 1. For this purpose one or several temperature sensors can be provided. One of such temperature sensors 5 is symbolically shown in FIG. 1. The temperature value of values T1 measured in the electrical device 1 are also transmitted to the evaluating circuit 4.

Instead of measuring the temperature T0, T1 in the current supplying unit 2 and/or 4 in the electrical device 1 directly, it is possible also to determine other variables which depend on the temperature and supply them to the evaluating circuit 4. Such variables which depend on the temperature, or in other words variables which allow making conclusions about the temperature, are for example the discharge current of an electric storage battery or the motor rotary speed or the motor torque of the electrical device in connection with the current taken by the motor.

A current limiting circuit 4 is provided in the current circuit between the current supplying unit 2 and electrical device 1. Thereby the maximum current I taken from the electrical device 1 or in other words the power draw of the electrical device can be reduced variably. The current limiting circuit 6 is activated by the evaluating circuit 4 when it is registered that the measured temperature T or a variable which depends on the temperature registers a predetermined threshold. When a temperature T is involved, then either the temperature T0 alone measured in the current supply unit 2, or the temperature T1 alone measured in the electrical device 1, or one of the two measured temperatures T0 and T1 is the involved temperature (for example by an average value formation). Subsequently always only generally the temperature T is involved. The exact operation of the evaluating circuit 4 and the current limiting circuit 6 is illustrated in FIGS. 2 and 3.

FIG. 2 shows a time course 7 of the temperature T, and FIG. 3 shows a stepped course 8 and a continuous course 9 of the current I taken by the electrical device 1 from the current supply unit 2. When here current I is involved, this means the current taken by the electrical device 1 when it operates with a maximum possible power.

As can be seen from FIG. 2, the temperature T increases until it exceeds a predetermined threshold S1 at a time point t1. The evaluating circuit 4 registers this exceeding of the threshold value and sends a corresponding information to the current limiting circuit 6. The current limiting circuit 6 reacts so that it reduces the current 1 from a value I₀ either stepped (in accordance with the course 8) or continuously (in accordance with the course 9). The current value I₀ corresponds to a current which the electrical device 1 takes at a maximum power. This is for example the case when the electric storage battery 2 connected to the electrical device 1 is charged and not overheated.

Since the current I is reduced either in steps or continuously, the increase of the temperature T always flattens and the temperature T finally falls under the threshold S1 at a time point t2. When the evaluating circuit 4 registers the drop of the temperature T under the threshold S1, the current limiting circuit 6 causes the reduction of the current 1 taken from the electrical device 1 to stop and simultaneously to increase either in steps or continuously. It is possible that the temperature T takes a longer time to again exceed the set threshold S1. Then the current I is reduced again to a complete turning off of the electrical device 1.

A second threshold S2 provided in the evaluating circuit 4 can be a trigger for the current limiting circuit 6 which ends the reduction of the current 1 in steps or continuously. The threshold S2 is located under the first threshold S1 which releases the reduction of the current 1. The course 7a in FIG. 2 shows at this lower second threshold S2 is exceeded by the temperature T first at a later time point t2′. At this time point t2′ an increase of the current 1 starts again.

It is to be understood when in the present application the threshold S1 and S2 are described, they not necessary are formed as concrete individual values, but also can be formed as value regions.

It will be understood that each of the elements described above, or two or more together, may also find a useful application in other types of methods and constructions differing from the types described above.

While the invention has been illustrated and described as embodied in method of and device for temperature-dependent control of power of electrical device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of controlling the power of an electrical device in dependence on a temperature, comprising the steps of determining a temperature or a variable which depends on the temperature of an element selected from the group consisting of a current supply unit connected with the electrical device, one or several components of the electrical device, and both; and when the determined temperature or a variable which depends on it exceeds a predetermined threshold, reducing power taken from the electrical device until the temperature or a variable which depends on it falls below said threshold or a lower threshold.

2. A method as defined in claim 1, wherein said reducing includes reducing the power taken from the electrical device in steps.

3. A method as defined in claim 1, wherein said reducing includes reducing the power taken from the electrical device continuously.

4. A method as defined in claim 1; and further comprising increasing the temperature or a variable which depends on the temperature in steps or continuously after the power taken from the electrical device exceeds the threshold.

5. A method as defined in claim 1; and further comprising controlling the power taken from the electrical device via a current supplied to the electrical device.

6. A method as defined in claim 1; and further comprising regulating the power taken from the electrical device via a current supplied to the electrical device.

7. A device for controlling the power of an electrical device depending on a temperature, comprising first means for detecting a temperature or a variable which depends on the temperature of an element selected from the group consisting of a current supply unit connected with the electrical device, one or several components of the electrical device, and both; and second means which, when the detected temperature or a value which depends on it exceeds a predetermined threshold, reduces power taken from the electrical device until the temperature or a value which depends on it falls below said threshold or a lower threshold.
